(19) United States
(12) Patent Application Publication
(10) Pub. No.: US 2012/0321900 A1
(43) Pub. Date: Dec. 20, 2012

(54) RADIATION-CURABLE AQUEOUS POLYURETHANE DISPERSIONS

(75) Inventors: Reinhold SCHWALM, Wachenheim (DE); Sebastian Roller, Mannheim (DE); Peter Thüry, Ludwigshafen (DE); Uwe Burkhardt, Ludwigshafen (DE); Sebastian Berger, Bobenheim-Roxheim (DE); Susanne Neumann, Speyer (DE)

(73) Assignee: BASF SE, Ludwigshafen (DE)

(21) Appl. No.: 13/523,363

(22) Filed: Jun. 14, 2012

Related U.S. Application Data
(60) Provisional application No. 61/496,604, filed on Jun. 14, 2011.

(51) Int. Cl. C08L 75/14; B05D 3/06; C09D 175/14; B32B 21/08; B82Y 30/00

(52) U.S. Cl. 428/425.1; 524/591; 427/487; 977/773

(57) ABSTRACT

The present invention relates to polyurethane dispersions that are curable with UV radiation, to a process for preparing them, and to the use thereof.

The present invention relates to aqueous polyurethane dispersions that are curable with UV radiation, to a process for preparing them, and to the use thereof.

For the coating of wood materials, as in the furniture industry, for instance, radiation-curable polyurethanes are widespread. In addition to requirements such as high hardness, coatings in the furniture industry are required in particular to emphasize the wood structure, an effect referred to as “grain highlighting”.

Water-dispersible, radiation-curable polyurethanes are known from EP 753531, for example, in which urethane acrylates are prepared on the basis of polyester acrylates, and EP 942022, in which urethane acrylates are prepared on the basis of prepolymers containing acrylate groups. The polyurethane acrylate dispersions described therein do not give sufficient emphasis to the wood structure.

In particular, the examples of EP 753531 show poor grain highlighting, as demonstrated in EP 1142947, example A therein, as comparative example.

Aqueous polyurethane dispersions with good grain highlighting are described in EP 1142947, for example. This effect is attributed to the incorporation of a particular monomer (the neopentyl glycol ester of hydroxypivalic acid). While the systems described therein do show significantly improved grain highlighting (rating 2) over the prior art, there is still need for improvement relative to the Laromer® PE 55W polyester acrylate reference used (rating 0).

It is an object of the present invention to provide polyurethanes which are curable with

UV radiation and are present in dispersion in water and which, on wood materials, exhibit good performance properties, more particularly a high level of hardness in conjunction with effective grain highlighting. For the dispersing of the polyurethanes, furthermore, there should be no need for solvents that are harmful to health, particularly N-methylpyrrolidone (NMP).

This object is achieved by means of radiation-curable polyurethanes which are present in dispersion in water, and are synthesized from
a) at least one aliphatic di- or polyisocyanate
b) at least one compound having at least one group that is reactive toward isocyanate groups, and at least one free-radically polymerizable C═C double bond,
c) optionally at least one compound having at least two groups that are reactive toward isocyanate groups, selected from hydroxyl, mercapto, primary and/or secondary amino groups,
d) at least one compound having at least one group that is reactive toward isocyanate groups, and at least one acid group,
e) at least one basic compound for neutralization or part-neutralization of the acid groups of the compounds d),
f) optionally at least one compound different from b), d) and e), containing only one group that is reactive toward isocyanate groups,
g) optionally at least one di- or polyisocyanate different from a),
h) optionally further additives, selected from reactive diluents, photoinitiators, and customary coatings additives,
i) water, and
k) optionally at least one diamine and/or polyamine,
   where the average diameter (z-average) of the particles, measured at 25° C. by means of dynamic light scattering using the Malvern® Zetasizer 1000, in the aqueous dispersion does not exceed 30 nm, preferably 25 nm, and

where the fraction of the NCO groups of component g) as a proportion of the total of NCO groups used, from compounds a) and g) is not more than 20 mol %.

In one preferred embodiment the polyurethanes prepared inventively, i.e., the reaction products of synthesis components a) to d) and also, optionally, f) and g), have a double bond density of at least 1.5 mol/kg, preferably at least 1.8, more preferably at least 2.0, and very preferably 2.2 mol/kg.

In the dispersions of the invention no isocyanate-functional compounds are used in which the isocyanate groups have been reacted in part or completely with what are called blocking agents. Blocking agents are compounds which convert isocyanate groups into blocked (capped or protected) isocyanate groups, which subsequently, below the temperature known as the deblocking temperature, do not display the customary reactions of a free isocyanate group. Such compounds with blocked isocyanate groups, which are not used inventively, are commonly employed in dual-cure coating compositions which are cured to completion via isocyanate group curing. The polyurethane dispersions of the invention, following their preparation, preferably no longer contain essentially any free isocyanate groups: that is, in general, less than 1% by weight NCO, preferably less than 0.75%, more preferably less than 0.66%, and very preferably less than 0.3% by weight NCO (calculated with a molar weight of 42 g/mol).

Component a)

Component a) comprises at least one, as for example one to three, preferably one to two, and more preferably exactly one aliphatic di- or polyisocyanate.

Aliphatic isocyanates are those which exclusively contain isocyanate groups attached to those carbon atoms which are part of linear or branched, acyclic chains, preferably those containing exclusively isocyanate groups which are attached to linear or branched, acylic chains and more preferably those which have isocyanate groups attached exclusively to linear or branched, acyclic hydrocarbon chains.

The aliphatic diisocyanates or polyisocyanates are preferably isocyanates having 4 to 20 C atoms. Examples of customary diisocyanates are tetramethylene 1,4-diisocyanate, pentamethylene 1,5-diisocyanate, hexamethylene 1,6-diisocyanate, 2-methyl-1,5-diisocyanatopentane, octamethylene 1,8-diisocyanate, decamethylene 1,10-diisocyanate, dodecamethylene 1,12-diisocyanate, tetradecamethylene 1,14-diisocyanate, 2,2,4- and 2,4,4-trimethylhexane diisocyanate, 1,3-bis(1-isocyanato-1-methylethyl)benzene (m-TMXDI), and derivatives of lysine diisocyanate. Mixtures of said diisocyanates may be present.

Preference is given to hexamethylene 1,6-diisocyanate and 2,2,4- and 2,4,4-trimethylhexane diisocyanate mixtures, more preferably to hexamethylene 1,6-diisocyanate.

Mixtures of said diisocyanates may also be present.

2,2,4- and 2,4,4-trimethylhexane diisocyanate are present in the form, for example of a mixture in a ratio of 1.5:1 to 1:1.5, preferably 1.2:1-1:1.2, more preferably 1.1:1-1:1.1 and very preferably 1:1.

The polyisocyanates may be monomeric isocyanates having more than two isocyanate groups or oligomers of the abovementioned diisocyanates. An example of the former is triisocyanatononane (4-isocyanatomethyloctane 1,8-diisocyanate) or 2′-isocyanatoethyl (2,6-diisocyanatohexanoate).

Examples of the latter are oligomers which contain isocyanurate, biuret, uretdione, allophanate, iminooxadiazinetrione and/or carbodiimide groups and which are obtainable by oligomerizing at least one, preferably exactly one, above-stated diisocyanate, more preferably by reaction of hexamethylene 1,6-diisocyanate.

Preferred polyisocyanates are oligomers containing isocyanurate, uretdione and/or allophanate groups, more preferably oligomers containing isocyanurate and/or allophanate groups, and, in one especially preferred embodiment, the compound a) is an oligomer which is based on hexamethylene 1,6-diisocyanate and contains allophanate groups, for which hexamethylene 1,6-diisocyanate is reacted with at least some of the compound b) to give an oligomer containing allophanate groups.

This reaction produces a compound having at least two free isocyanate groups, at least one allophanate group, and at least one free-radically polymerizable C═C double bond attached to the allophanate group, via its group that is reactive toward isocyanate groups.

One such component a) comprises an amount of allophanate groups (calculated as C₂N₂HO₃=101 g/mol) of 1% to 35%, preferably from 5% to 30%, more preferably from 10% to 35% by weight. The polyurethanes of the invention formed from the synthesis components a) to d) and also, optionally, f) and g) comprise 1% to 30%, preferably from 1% to 25%, more preferably from 2% to 20% by weight of allophanate groups. The component a) used inventively further comprises less than 5% by weight of uretdione.

Preference is given to compounds of the formula below

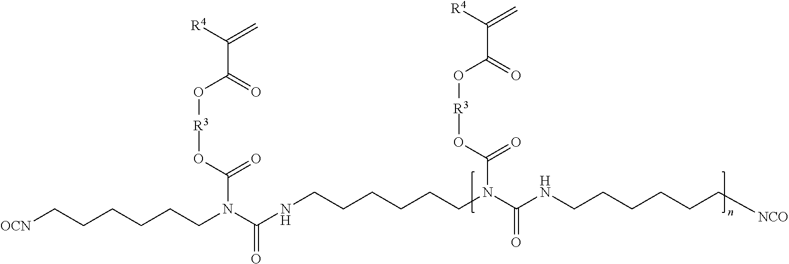

in which

R³ is a divalent aliphatic or cycloaliphatic, preferably aliphatic radical, preferably hydrocarbon radical, which has 2 to 12, preferably 2 to 8, and more preferably 2 to 4 carbon atoms,

R⁴ is hydrogen or methyl, preferably hydrogen, and

n is able on average to take on 0 or a positive number, preferably values from 0 to 5, more preferably 0.5 to 3 and very preferably 1 to 2.

Examples of R³ are 1,2-ethylene, 1,1-dimethyl-1,2-ethylene, 1,2-propylene, 1,3-propylene, 2-methyl-1,3-propylene, 2-ethyl-1,3-propylene, 2-butyl-2-ethyl-1,3-propylene, 2,2-dimethyl-1,3-propylene, 1,2-butylene, 1,3-butylene, 1,4-butylene, 1,5-pentylene, 1,6-hexylene, 2-ethyl-1,3-hexylene, 1,8-octylene, 2,4-diethyl-1,3-octylene or 1,10-decylene, preferably 1,2-ethylene, 1,2-propylene, 1,3-propylene or 1,4-butylene, more preferably 1,2-ethylene or 1,2-propylene and very preferably 1,2-ethylene.

This component preferably has an NCO content of 10% to 18%, preferably 12% to 16%, and more preferably 13% to 16% by weight and an average molecular weight of 600 to 1200, preferably 700 to 1000 and more preferably of 700 to 900 g/mol.

Compounds of this kind are available commercially, for example, under the trade name Laromer® 9000 from BASF SE, Ludwigshafen.

The preparation of such compounds is known from WO 00/39183 A1, particularly example 1.1. and products 1 to 7 from table 1 therein.

Component b)

Component b) comprises at least one, preferably one to three, more preferably one or two, and very preferably exactly one compound having at least one, as for example one or two, preferably exactly one group that is reactive toward isocyanate groups, and at least one, as for example one to three, preferably one or two, and very preferably exactly one free-radically polymerizable C═C double bond.

Free-radically polymerizable C═C double bonds are vinyl ether, acrylate or methacrylate groups, preferably acrylate or methacrylate groups, and more preferably acrylate groups.

Preferred compounds of components b) are, for example the esters of dihydric or polyhydric alcohols with α,β-ethylenically unsaturated monocarboxylic and/or dicarboxylic acids and their anhydrides, in which at least one hydroxyl group remains unreacted.

Examples of α,β-ethylenically unsaturated monocarboxylic and/or dicarboxylic acids and their anhydrides that can be used include acrylic acid, methacrylic acid, fumaric acid, maleic acid, maleic anhydride, crotonic acid, itaconic acid, etc. It is preferred to use acrylic acid and methacrylic acid, more preferably acrylic acid.

Examples of suitable dihydric or polyhydric alcohols are diols such as ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol, and tricyclodecanedimethanol.

Suitable triols and polyols have, for example, 3 to 25, preferably 3 to 18, carbon atoms. Examples include trimethylolbutane, trimethylolpropane, trimethylolethane, pentaerythritol, glycerol, ditrimethylolpropane, dipentaerythritol, ditrimethylolpropane, sorbitol, mannitol, diglycerol, threitol, erythritol, adonitol(ribitol), arabitol(lyxitol), xylitol, dulcitol(galactitol), maltitol or isomalt.

Preferably the compounds of component b) are selected from 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, trimethylolpropane mono- or diacrylate, pentaerythritol di- or triacrylate, and mixtures thereof.

With particular preference the compound b) is selected from the group consisting of 2-hydroxyethyl acrylate, 2-hydroxyethyl methacrylate, 2-hydroxypropyl acrylate, 2-hydroxypropyl methacrylate, 4-hydroxybutyl acrylate and pentaerythritol triacrylate, very preferably from the group consisting of 2-hydroxyethyl acrylate, 2-hydroxyethyl methacrylate, 2-hydroxypropyl acrylate, and 2-hydroxypropyl methacrylate and more particularly it is 2-hydroxyethyl acrylate or 2-hydroxyethyl methacrylate.

Component c)

The optional component c) comprises at least one compound having at least two, as for example 2 to 4, preferably 2 to 3 and more preferably exactly 2 groups that are reactive toward isocyanate groups, these groups being selected from hydroxyl, mercapto, and primary and/or secondary amino groups, more preferably from the group consisting of hydroxyl groups and primary amino groups, and more preferably hydroxyl groups.

The compounds c) are low molecular weight compounds having a molecular weight of below 500 g/mol, preferably below 400 g/mol, very preferably below 250 g/mol.

The low molecular weight alcohols c) may be aliphatic or cycloaliphatic, preferably aliphatic.

The hydroxyl groups may preferably be secondary or primary, preferably primary.

Particularly preferred are alcohols having 2 to 20 carbon atoms. Preference is given in particular to hydrolysis-stable, short-chain diols having 4 to 20, preferably 6 to 12, carbon atoms. With very particular preference, the compounds c) are alkane diols.

Examples of compounds c) are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclohexanedimethanol, 1,2-, 1,3- or 1,4-cyclohexanediol.

Preference is given to ethylene glycol, 1,2-propanediol, 1,3-propanediol, neopentyl glycol, 1,4-butanediol, 1,6-hexanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, and particular preference to ethylene glycol, 1,2-propanediol, 1,3-propanediol, neopentyl glycol, 1,4-butanediol or 1,6-hexanediol.

In accordance with the invention no substantial amounts of relatively high molecular weight diols or polyols, with a molecular weight of more than 500 g/mol, are used.

“No substantial amounts” here means that the fraction of the OH groups of the diols or polyols of relatively high molecular weight as a proportion of the total OH groups used, from the compounds b), c), d) and f) is not more than 20 mol %, preferably not more than 15 mol %, more particularly not more than 10, very preferably not more than 5, and more particularly 0 mol %.

The aforementioned components c) can be used individually or as mixtures.

Component d)

Component d) is at least one, preferably exactly one, compound having at least one, as for example one to three, preferably one or two, more preferably exactly two, groups that are reactive toward isocyanate groups, and having at least one, preferably precisely one, acid group.

The acid groups of the compounds of component d) are preferably selected from carboxylic acid groups, sulfonic acid groups, phosphonic acid groups, and phosphoric acid groups. Preference is given to carboxylic acid and sulfonic acid groups, particular preference to carboxylic acid groups.

Suitable compounds d) having at least one isocyanate-reactive group and also at least one carboxylic acid or sulfonic acid group include, in particular, aliphatic monomercapto, monohydroxy, and monoamino and imino carboxylic acids and corresponding sulfonic acids, such as mercaptoacetic acid (thioglycolic acid), mercaptopropionic acid, mercaptosuccinic acid, hydroxyacetic acid, hydroxypropionic acid (lactic acid), hydroxysuccinic acid, hydroxypivalic acid, dimethylolpropionic acid, dimethylolbutyric acid, hydroxydecanoic acid, hydroxydodecanoic acid, 12-hydroxystearic acid, N-(2′-aminoethyl)-3-aminopropionic acid, hydroxyethanesulfonic acid, hydroxypropanesulfonic acid, mercaptoethanesulfonic acid, mercaptopropanesulfonic acid, aminoethanesulfonic acid, aminopropanesulfonic acid, glycine (aminoacetic acid), N-cyclohexylaminoethanesulfonic acid, N-cyclohexylaminopropanesulfonic acid, or iminodiacetic acid.

Preference is given to dimethylolpropionic acid and dimethylolbutyric acid, particular preference to dimethylolpropionic acid.

Component e)

Component e) is at least one basic compound for complete or partial neutralization of the acid groups of compounds d).

Suitable basic compounds e) for complete or partial neutralization of the acid groups of compounds d) include organic and inorganic bases such as alkali metal and alkaline earth metal hydroxides, oxides, carbonates, and hydrogencarbonates, and also ammonia or primary, secondary or tertiary amines. Preference is given to complete or partial neutralization with amines such as with ethanolamine or diethanolamine and in particular with tertiary amines, such as triethylamine, triethanolamine, dimethylethanolamine or diethylethanolamine. The amounts of chemically bonded acid groups introduced, and the extent of neutralization of the acid groups (which is usually 40% to 100% of the equivalent basis), ought preferably to be enough to ensure that the polyurethanes are dispersed in an aqueous medium, this being familiar to the skilled person.

Component f)

In the dispersions of the invention as component f) it is possible to use at least one further compound having a group which is reactive toward isocyanate groups. This group can be a hydroxyl or mercapto group or a primary or secondary amino group.

Suitable compounds f) are the customary compounds known to the skilled worker, which are used conventionally in polyurethane preparation as stoppers for lowering the number of reactive free isocyanate groups or for modifying the polyurethane properties. Examples include monofunctional alcohols, such as methanol, ethanol, n-propanol, isopropanol, n-butanol etc. Suitable components f) are also amines having one primary or secondary amino group, such as methylamine, ethylamine, n-propylamine, diisopropylamine, dimethylamine, diethylamine, di-n-propylamine, diisopropylamine etc.

Component g)

In the dispersions of the invention it is possible as optional components g) to use at least one polyisocyanate which is different from the compounds of components a) in subordinate amounts. As components g) in accordance with the invention no use is made of polyisocyanates where the isocyanate groups have been reacted with a blocking agent.

Preferred compounds g) are polyisocyanates having an NCO functionality of 2 to 4.5, more preferably 2 to 3.5. As component g) it is preferred to use aliphatic, cycloaliphatic, and araliphatic diisocyanates. These may be, for example, the diisocyanates set out above under a), but are different from the compound a). Preferred compounds g) have 2 or more isocyanate groups and also a group selected from the group of urethane, urea, biuret, allophanate, carbodiimide, uretonimine, uretdione, and isocyanurate groups.

The compound g) preferably comprises cycloaliphatic or aromatic, preferably cycloaliphatic, di- and polyisocyanates.

Cycloaliphatic isocyanates are those containing at least one isocyanate group attached to a carbon atom that is part of a completely saturated ring system, preferably those containing at least one isocyanate group attached to a carbon atom that is part of a nonaromatic carbocyclic ring system.

Aromatic isocyanates are those containing at least one isocyanate group attached to a carbon atom which is part of an aromatic ring system.

Examples of cycloaliphatic diisocyanates are 1,4-, 1,3- or 1,2-diisocyanatocyclohexane, 4,4′- or 2,4′-di(isocyanatocyclohexyl)methane, isophorone diisocyanate, 1,3- or 1,4-bis-(isocyanatomethyl)cyclohexane, 2,4-, and 2,6-diisocyanato-1-methylcyclohexane. Examples of aromatic diisocyanates are tolylene 2,4- or 2,6-diisocyanate, m- or p-xylylene diisocyanate, 2,4′- or 4,4′-diisocyanatodiphenylmethane, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethyldiphenyl diisocyanate, 3-methyldiphenylmethane 4,4′-diisocyanate and diphenyl ether 4,4′-diisocyanate. Mixtures of the stated diisocyanates may be present.

Preferred use is made as component g) of isophorone diisocyanate, 1,3- and 1,4-bis(isocyanatomethyl)cyclohexane, their isocyanurates, biurets, and mixtures thereof.

In one preferred embodiment of the present invention no or no substantial amounts of component g) are to be used, preferably no component g).

By “no substantial amount” here is meant that the fraction of the NCO groups of component g) as a proportion of the total NCO groups used, from compounds a) and g), is not more than 20 mol %, preferably not more than 15 mol %, more preferably not more than 10, very preferably not more than 5, and more particularly 0 mol %.

Component h)

The dispersion of the invention may comprise at least one further compound such as is normally employed as a reactive diluent. These include, for example, the reactive diluents as described in P. K. T. Oldring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Preferred reactive diluents are compounds different from component b) which have at least one free-radically polymerizable C═C double bond.

Examples of reactive diluents include esters of (meth)acrylic acid with alcohols which have 1 to 20 C atoms, e.g., methyl(meth)acrylate, ethyl(meth)acrylate, butyl(meth)acrylate, 2-ethylhexyl(meth)acrylate, 2-hydroxyethyl acrylate, 4-hydroxybutyl acrylate, dihydrodicyclopentadienyl acrylate, vinylaromatic compounds, e.g., styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g., cyclopentene, cyclohexene, cyclododecene, N-vinylformamide, allylacetic acid, vinylacetic acid, monoethylenically unsaturated carboxylic acids having 3 to 8 C atoms and also their water-soluble alkali metal, alkaline earth metal or ammonium salts, such as, for example: acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid, N-vinylpyrrolidone, N-vinyl lactams, such as N-vinylcaprolactam, N-vinyl-N-alkylcarboxamides or N-vinyl-carboxamides, such as N-vinylacetamide, N-vinyl-N-methylformamide, and N-vinyl-N-methylacetamide or vinyl ethers, e.g., methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, 4-hydroxybutyl vinyl ether, and mixtures thereof.

Compounds having at least two free-radically polymerizable C═C double bonds: these include, in particular, the diesters and polyesters of the aforementioned α,β-ethylenically unsaturated monocarboxylic and/or dicarboxylic acids with diols or polyols. Particularly preferred are hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, pentaerythritol diacrylate, dipentaerythritol tetraacrylate, dipentaerythritol triacrylate, pentaerythritol tetraacrylate, etc. Also preferred are the esters of alkoxylated polyols, with α,β-ethylenically unsaturated monocarboxylic and/or dicarboxylic acids, such as the polyacrylates or polymethacrylates of alkoxylated trimethylolpropane, glycerol or pentaerythritol. Additionally suitable are the esters of alicyclic diols, such as cyclohexanediol di(meth)acrylate and bis(hydroxymethylethyl)cyclohexane di(meth)acrylate. Further suitable reactive diluents are trimethylolpropane monoformal acrylate, glycerol formal acrylate, 4-tetrahydropyranyl acrylate, 2-tetrahydropyranyl methacrylate, and tetrahydrofurfuryl acrylate.

One preferred embodiment of the present invention is not to use any low molecular weight reactive diluents, meaning that such reactive diluents are to be used only in amounts of not more than 5% by weight, more preferably in amounts of not more than 1% by weight.

“Low molecular weight reactive diluents” here are compounds having one or two free-radically polymerizable C═C double bonds and a molecular weight of not more than 500 g/mol.

Where the dispersions of the invention are cured not with electron beams but instead by means of UV radiation, the preparations of the invention preferably comprise at least one photoinitiator which is able to initiate the polymerization of ethylenically unsaturated double bonds.

Photoinitiators may be, for example, photoinitiators known to the skilled person, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed, for example, by mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF SE), ethyl 2,4,6-trimethylbenzoylphenylphosphinate (Lucirin® TPO L from BASF SE), bis(2,4,6-trimethylbenzoyl)phenylphosphine oxide (Irgacure® 819 from BASF SE, formerly Ciba Spezialitatenchemie), benzophenones, hydroxyacetophenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracene-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tent-butylanthraquinone, 1-chloroanthraquinone, and 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethyl-pentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethylbenzophenone and 4-methylbenzophenone or 2,4,6-trimethylbenzophenone, and 4-methylbenzophenone and 2,4,6-trimethylbenzoyldiphenylphosphine oxide.

Preference among these photoinitiators is given to 2,4,6-trimethylbenzoyldiphenyl-phosphine oxide, ethyl 2,4,6-trimethylbenzoylphenylphosphinate, bis(2,4,6-tri-methylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

The dispersions of the invention comprise the photoinitiators preferably in an amount of 0.05% to 10%, more preferably 0.1% to 8%, in particular 0.2% to 5%, by weight based on the total amount of components a) to h).

The dispersions of the invention preferably contain no thermal initiators.

Thermal initiators for the purposes of the present invention are those which have a half-life at 60° C. of at least one hour. The half-life of a thermal initiator is the time taken for half the initial amount of the initiator to decompose into free radicals.

Thermal initiators are preferably absent in accordance with the invention, being present therefore in amounts of less than 0.1% by weight.

The dispersions of the invention may comprise further customary coatings additives, such as flow control agents, defoamers, UV absorbers, dyes, pigments and/or fillers.

Suitable fillers comprise silicates, e.g., silicates obtainable by hydrolysis of silicon tetrachloride, such as Aerosil® from Degussa, siliceous earth, talc, aluminum silicates, magnesium silicates, and calcium carbonates, etc. Suitable stabilizers comprise typical UV absorbers such as oxanilides, triazines, and benzotriazole (the latter obtainable as Tinuvin R grades from the former Ciba-Spezialitatenchemie, now BASF), and benzophenones. They can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used usually in amounts of 0.1% to 5.0% by weight, based on the “solid” components comprised in the preparation.

Component k)

Polyamines having 2 or more primary and/or secondary amino groups can be used in particular when the chain extension and/or crosslinking is to take place in the presence of water, since amines generally react quicker with isocyanates than do alcohols or water. This is often necessary when aqueous dispersions of crosslinked polyurethanes or polyurethanes of high molar weight are desired. In such cases the procedure is to prepare prepolymers containing isocyanate groups, to disperse them rapidly in water, and then, by adding compounds having two or more isocyanate-reactive amino groups, to subject them to chain extension or crosslinking.

Amines suitable for this purpose are generally polyfunctional amines of the molar weight range from 32 to 500 g/mol, preferably from 60 to 300 g/mol, which comprise at least two primary, two secondary or one primary and one secondary amino group(s). Examples of such are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane, or higher amines such as triethylenetetramine, tetraethylenepentamine or polymeric amines such as polyethyleneamines, hydrogenated polyacrylonitriles, or at least partially hydrolyzed poly-N-vinylformamides, in each case with a molar weight of up to 2000, preferably up to 1000 g/mol.

The amines can also be employed in blocked form, e.g., in the form of the corresponding ketimines (see, e.g., CA-1 129 128), ketazines (cf., e.g., U.S. Pat. No. 4,269,748) or amine salts (see U.S. Pat. No. 4,292,226). Oxazolidines as well, as are used, for example, in U.S. Pat. No. 4,192,937, represent capped polyamines, which can be used for preparing the polyurethanes for chain-extending the prepolymers. When using capped polyamines of this kind they are generally blended with the prepolymers in the absence of water and this mixture is subsequently mixed with the dispersion water or with a portion of the dispersion water, so that the corresponding polyamines are liberated by hydrolysis.

It is preferred to use mixtures of diamines and triamines, more preferably mixtures of isophoronediamine and diethylenetriamine.

The fraction of polyamines can be up to 10 mol %, preferably up to 8 mol %, and more preferably up to 5 mol %, based on the total amount of C═C double bonds.

The solids content of the aqueous dispersions of the invention is preferably situated within a range from about 5% to 70%, preferably 20% to 60%, more preferably 30% to 50% by weight.

Preferred dispersions are those where, of the isocyanate groups of the compounds of component a) and, if present, g),
20 to 99 mol %, preferably 40 to 90 mol %, more preferably 55-82 mol % have undergone reaction with groups of at least one compound of component b) that are reactive toward isocyanate groups,
0 to 50 mol %, preferably 5 to 40 mol %, more preferably 10-30 mol %, have undergone reaction with groups of at least one compound of component c) that are reactive toward isocyanate groups,
1 to 25 mol %, preferably 5 to 20 mol %, more preferably 8 to 15 mol % have undergone reaction with groups of at least one compound of component d) toward isocyanat groups that are reactive.
0 to 5 mol %, preferably 0 to 2 mol %, more preferably 0 mol % have undergone reaction with toward isocyanate groups of at least one compound of component d).

The figures relate to molar equivalents of a functional group.

Particularly preferred dispersions are those which per kg of polyurethane, based on the sum of components a) to d) and e) to g), have an amount of neutralized or free acid groups from d) that is at least 0.4 mol, preferably at least 0.45 mol/kg.

As a result of this amount it is possible with preference to do without the use of organic solvents, more particularly of N-methylpyrrolidone, for dispersing, meaning that the VOC content of the dispersions of the invention is not increased by these organic solvents.

The dispersions of the invention are particularly suitable as coating material or in coating materials, more preferably for coating substrates such as wood, paper, textile, leather, nonwoven, plastics surfaces, glass, ceramic, mineral building materials, such as cement moldings and fiber-cement slabs, and, in particular, for coating metals or coated metals.

The dispersions of the invention can be used with particular advantage for coating wood and wood materials and wood-containing substrates, such as fiberboard. Also conceivable would be the coating of substrates containing cellulose fiber, such as paper, paperboard or cardboard, for example. With very particular preference the dispersions are suitable for the coating of oak, spruce, pine, beech, maple, walnut, macoré, chestnut, plane, robinia, ash, birch, stone pine and elm, and also cork.

After curing by high-energy radiation, the dispersions of the invention advantageously form films having good performance properties, more particularly a high level of hardness in conjunction with sufficient elasticity and with good grain highlighting too.

The substrates are coated in accordance with customary methods that are known to the skilled person, involving the application of at least one dispersion of the invention to the substrate that is to be coated, in the desired thickness, and removal of the volatile constituents of the dispersions by drying and/or flashing off at ambient or elevated temperature up to 60° C. for example.

This process can be repeated one or more times if desired. Application to the substrate may take place in a known way, e.g., by spraying, troweling, knifecoating, brushing, rolling, roller-coating or pouring. The coating thickness is generally situated within a range from about 3 to 1000 g/m² and preferably 10 to 200 g/m².

Optionally, if two or more films of the coating material are applied one on top of another, a radiation cure may take place after each coating operation.

Radiation curing is accomplished by exposure to high-energy radiation, i.e., UV radiation or daylight, preferably light with a wavelength of 250 to 600 nm, or by irradiation with high-energy electrons (electron beams; 150 to 300 keV). Examples of radiation sources used include high-pressure mercury vapor lamps, lasers, pulsed lamps (flashlight), halogen lamps or excimer emitters. The radiation dose normally sufficient for crosslinking in the case of UV curing is situated within the range from 80 to 3000 mJ/cm².

Irradiation may also optionally be carried out in the absence of oxygen, e.g., under an inert gas atmosphere. Suitable inert gases include, preferably, nitrogen, noble gases, carbon dioxide or combustion gases. Irradiation may also take place with the coating material being covered by transparent media. Transparent media are, for example, polymeric films, glass or liquids, e.g., water. Particular preference is given to irradiation in the manner as is described in DE-A1 199 57 900.

In one preferred process, curing takes place continuously, by passing the substrate treated with the preparation of the invention at constant speed past a radiation source. For this it is necessary for the cure rate of the preparation of the invention to be sufficiently high.

This varied course of curing over time can be exploited in particular when the coating of the article is followed by a further processing step in which the film surface comes into direct contact with another article or is worked on mechanically.

The advantage of the dispersions of the invention is that the coated articles can be processed further immediately following the radiation cure, since the surface is no longer sticky. On the other hand, the dried film is still sufficiently flexible and stretchable that the article can still be deformed without the film flaking or tearing.

The invention is illustrated by means of the following nonlimiting examples.

### EXAMPLES

### Example 1

### Preparation of an Inventive Polyurethane Acrylate Dispersion

In a stirred tank, 78 parts of hydroxyethyl acrylate, 37 parts of neopentyl glycol, 47 parts of dimethylolpropionic acid, 572 parts of an acrylated polyisocyanate (Laromer® LR 9000, BASF SE), 0.4 part of 2,6-di-tert-butyl-p-cresol, 0.5 part of hydroquinone monomethyl ether and 184 parts of acetone were introduced and at room temperature 0.5 part of dibutyltin dilaurate was added. This initial charge was heated to 80° C. and reacted at 80° C. for 6 hours. It was then diluted with 130 parts of acetone. The NCO value was 0.24%. Following addition of 184 parts of 10% strength sodium hydroxide solution, 1400 parts of water were added dropwise over the course of 45 minutes. The acetone was then distilled off under reduced pressure. Water was added to adjust the solids content to 30%. The viscosity was 320 mPas and the particle size of the translucent dispersion was 21 nm.

### Example 2

### Preparation of an Inventive Polyurethane Acrylate Dispersion

In a stirred tank, 113 parts of hydroxyethyl acrylate, 69 parts of dimethylolpropionic acid, 553 parts of an acrylated polyisocyanate (Laromer® LR 9000, BASF SE), 0.4 part of 2,6-di-tert-butyl-p-cresol, 0.5 part of hydroquinone monomethyl ether and 184 parts of acetone were introduced and at room temperature 0.5 part of Borchi® Kat 24 (bismuth carboxylate) was added. This initial charge was heated to 80° C. and reacted at 80° C. for 6 hours. It was then diluted with 130 parts of acetone. The NCO value was 0.15%. Following addition of 184 parts of 10% strength sodium hydroxide solution, 1200 parts of water were added dropwise over the course of 45 minutes. The acetone was then distilled off under reduced pressure. The solids content was 37%. The viscosity was 6200 mPas and the particle size of the translucent solution was below 20 nm.

### Comparative Example 1

Example 3 from EP 1 142 947 was reworked (polyurethane acrylate comprising Laromer® PE 44F, BASF SE, dimethylolpropionic acid, neopentyl glycol, neopentyl glycol hydroxypivalate, isophorone diisocyanate and hexamethylene diisocyanate). The solids content was 38+/−2%. The particle size was found to be 54 nm.

### Comparative Example 2

In a stirred tank, 60 parts of hydroxyethyl acrylate, 36 parts of dimethylolpropionic acid, 56 parts of neopentyl glycol, 582 parts of an acrylated polyisocyanate (Laromer® LR 9000, BASF SE), 0.4 part of 2,6-di-tert-butyl-p-cresol, 0.5 part of hydroquinone monomethyl ether and 184 parts of acetone were introduced and at room temperature 0.5 part of Borchi® Kat 24 (bismuth carboxylate) was added. This initial charge was heated to 80° C. and reacted at 80° C. for 6 hours. It was then diluted with 130 parts of acetone. The NCO value was 0.15%. Following addition of 97 parts of 10% strength sodium hydroxide solution, 1500 parts of water were added dropwise over the course of 45 minutes. The acetone was then distilled off under reduced pressure. The solids content was adjusted to 30%. The viscosity was 1380 mPas and the particle size was 67 nm.

### Comparative Example 3

Example 2 was repeated, but with the 553 parts of Laromer® LR 9000 replaced by a mixture of 290 parts of Laromer® LR9000 and 260 parts of an isophorone diisocyanate isocyanurate (Vestanat® T1890 from Evonik).

The viscosity of the dispersion was 580 mPas and the particle size was smaller than 20 nm.

Performance Testing

Production of Films

The dispersions or solutions from examples 1 and 2, and from comparative examples 1 and 2 were admixed with 4% by weight of Irgacure® 500 photoinitiator (BASF SE, formerly Ciba Spezialitätenchemie) and applied to a pre-sanded wood substrate, using a 200 μm four-way bar applicator.

The coated substrate was flashed at room temperature for 15 minutes and at 60° C. in a forced-air oven for 30 minutes, and irradiated in an IST UV unit, on a conveyer belt at 10 m/min with 2 UV lamps (120 W/cm). It was then re-sanded (160 grade) and subsequently coated again (as above), dried and UV cured. The films were physically dry and through-cured (fingernail test).

| | | | | | Comparative | | Comparative | | Comparative | |
|---|---|---|---|---|---|---|---|---|---|---|
| | Example 1 | | Example 2 | | example 1 | | example 2 | | example 3 | |
| Solids | 30% | by weight | 37% | by weight | 38% | by weight | 30% | by weight | 26% | by weight |
| content 1) | | | | | | | | | | |
| Viscosity 2) | 320 | mPas | 6200 | mPas | 30 | mPas | 1380 | mPas | 580 | mPas |
| pH | 7.6 | | 7.6 | | 8.6 | | 7.6 | | | |
| Appearance | translucent | | translucent | | milky, white | | milky, white | | | |
| Particle size 3) | 21 | nm | <20 | nm | 54 | nm | 67 | nm | <20 | nm |

| | | | | | |
|---|---|---|---|---|---|
| Grain | 1 | 1 | 3 | 3 | 4 |
| highlighting 4) | | | | | |
| Grain | 1 | 2 | 3 | 3 | 4 |
| highlighting 5) | | | | | |
| Pendulum | 133 | 134 | 71 | 126 | |
| hardness 6) | | | | | |
| Erichsen | 4.7 | 4.4 | 6.8 | 5.2 | |
| cupping 7) | | | | | |

1) According to DIN EN ISO 3251 (1 g at 125° C.)
2) Rotary viscometer 23° C. at 50 s⁻¹
3) Average particle size from Malvern ® Zetasizer 1000, Malvern Instruments, Malvern, UK
4) Film drawdown on walnut, visual assessment according to ratings, rating 1 = best result, rating 4 = worst result. The benchmark was a 100% UV formulation based on an amine-modified polyester acrylate (Laromer ® PO 84F) with good grain highlighting: rating 1).
5) Film drawdown on oak, visual assessment according to ratings, rating 1 = best result, rating 4 = worst result. The benchmark was a 100% UV formulation based on an amine-modified polyester acrylate (Laromer ® PO 84F) with good grain highlighting: rating 1).
6) Pendulum hardness by König method DIN 53157 (swings) after UV curing
7) Erichsen cupping (mm) DIN EN ISO 1520

1. A dispersion, comprising water and a radiation-curable polyurethane comprising, in polymerized form:
a) at least one aliphatic di- or polyisocyanate
b) a compound comprising a group that is reactive toward isocyanate groups, and a free-radically polymerizable C═C double bond;
c) optionally, a compound having a molecular weight of less than 500 g/mol and comprising at least two groups that are reactive toward isocyanate groups selected from the group consisting of hydroxyl, mercapto, primary amino, and secondary amino groups;
d) a compound comprising a group that is reactive toward isocyanate groups, and an acid group;
e) a basic compound, which neutralizes, at least partially, the acid groups of the compound d);
f) optionally, compound different from b), d) and e), comprising only one group that is reactive toward isocyanate groups;
g) optionally, a di- or polyisocyanate different from a);
h) optionally, at least one additive selected from the group consisting of a reactive diluent, a photoinitiator, and a customary coating additive; and
i) optionally, at least one selected from the group consisting of a diamine and a polyamine,
wherein the average diameter (z-average) of particles of the polyurethane, measured at 25° C. by means of dynamic light scattering using the Malvern® Zetasizer 1000, in the dispersion does not exceed 30 nm, and
wherein a fraction of the NCO groups of component g) as a proportion of the total amount of NCO groups used, from compounds a) and g) is not more than 20 mol %.

2. The dispersion of claim 1, wherein the component a) is an oligomer of hexamethylene 1,6-diisocyanate comprising allophanate groups wherein the hexamethylene 1,6-diisocyanate is reacted with at least a portion of compound b) to produce an oligomer comprising allophanate groups.

3. The dispersion of claim 1, wherein component b) is 2-hydroxyethyl acrylate, 2-hydroxyethyl methacrylate, 2 hydroxypropyl acrylate, 2-hydroxypropyl methacrylate, 3-hydroxybutyl acrylate, 3 hydroxybutyl methacrylate, 4-hydroxybutyl acrylate, 4-hydroxybutyl methacrylate, 6 hydroxyhexyl acrylate, 6-hydroxyhexyl methacrylate, 3-hydroxy-2-ethylhexyl acrylate, 3 hydroxy-2-ethylhexyl methacrylate, monoacrylate, trimethylolpropane, diacrylate, pentaerythritol diacrylate, triacrylate, or any combination thereof.

4. The dispersion of claim 1, wherein component c) is an aliphatic or cycloaliphatic compound.

5. The dispersion of claim 1, wherein component d) is selected from the group consisting of dimethylolpropionic acid and dimethylolbutyric acid.

6. A substrate, comprising a coating comprising the dispersion of claim 1.

7. The substrate of claim 6, further comprising oak, spruce, pine, beech, maple, chestnut, plane, robinia, ash, birch, stone pine, elm, walnut or macoré.

8. A method for coating a substrate, the method comprising:
applying the dispersion of claim 1 to a substrate, to obtain a coated substrate;
drying the coated substrate to obtain a dry substrate, and
radiation-curing the dried substrate.

9. The method of claim 8, wherein the substrate comprises oak, spruce, pine, beech, maple, chestnut, plane, robinia, ash, birch, stone pine, elm, walnut, or macoré.

10. A coating material comprising the dispersion of claim 1.

11. The coating material of claim 10, which is suitable for coating wood, paper, textile, leather, nonwoven, a plastic surface, glass, ceramic, a mineral building material, a metal, a coated metal, paper, paperboard, or cardboard.

12. The to coating material of claim 11, which is suitable for coating oak, spruce, pine, beech, maple, chestnut, plane, robinia, ash, birch, stone pine, elm, walnut, macoré, or cork.

13. The dispersion of claim 1, wherein the polyurethane has double bond density of at least 1.5 mol/kg.

14. The dispersion of claim 1, wherein the polyurethane has a double bond density of at least 1.8 mol/kg.

15. The dispersion of claim 1, wherein the polyurethane has a double bond density of at least 2.0 mol/kg.

16. The dispersion of claim 1, wherein component c) is present and is an aliphatic alcohol.

17. The dispersion of claim 1, wherein component c) is present and is a cycloaliphatic alcohol.

18. The dispersion of claim 1, wherein component d) is dimethylolpropionic acid.

19. The dispersion of claim 1, wherein component d) is dimethylolbutyric acid.

20. The dispersion of claim 1, wherein the average diameter the particles in the dispersion does not exceed 25 nm.
